(19) United States
(12) Patent Application Publication
(10) Pub. No.: US 2023/0016956 A1
(43) Pub. Date: Jan. 19, 2023

(54) SYSTEM AND METHOD FOR ON-DEMAND OWNERSHIP MANAGEMENT

(71) Applicant: KEY LIVING CORPORATION, Toronto (CA)

(72) Inventors: Robert Donald RICHARDS, Toronto (CA); Yash MODY, Toronto (CA); Derek Jack MANUGE, Toronto (CA)

(21) Appl. No.: 17/782,804

(22) PCT Filed: Dec. 18, 2020
(86) PCT No.: PCT/IB2020/062242

§ 371 Date: Jun. 6, 2022

Related U.S. Application Data
(60) Provisional application No. 62/952,237, filed on Dec. 21, 2019.
(60) Provisional application No. 62/994,506, filed on Mar. 25, 2020.

(51) Int. Cl. G06Q 50/16

(52) U.S. Cl. CPC G06Q 50/167

(57) ABSTRACT

An on-demand property ownership management system (OMS) and a contractual obligation engine (COE) for facilitating consumer financial and ownership transactions. The OMS includes one or more computer servers configured to coordinate transactions between disparate entities, including at least one consumer and one or more local property management servers (LPMS). An example method for creating and maintaining a consumer profile, includes establishing bidirectional communication between a requesting consumer and the OMS and obtaining preferences concerning property ownership, and a request from the consumer for property ownership. The OMS then searches for matching properties available via the LPMS, and upon consumer selection of a desired property enable a financial transaction and an ownership and occupancy change transaction and record that in the OMS, and provide confirmation to the consumer along with a date and time for the requesting consumer to move into the property.

### FIELD

The present description relates to computer-implemented asset management, and in particular to a distributed on-demand property ownership management system (OMS) and a contractual obligation engine (COE) for facilitating consumer financial and ownership transactions.

### BACKGROUND

Property ownership has become increasingly unattainable for many people living in fast-growing cities around the world. Real estate is expensive, requiring a substantial down payment and long-term debt commitment from consumers. High costs, in terms of real estate agent commissions and change of title costs are typically associated with buying and selling traditional real estate.

To mitigate this situation and allow for consumers to more easily enter the housing market, many different methods have been attempted. Rent-to-own and lease-to-own are alternatives for property buyers who may have difficulty qualifying for a mortgage or may not have the requisite down payment saved.

A rent-to-own property is a property that can be bought through a rent-to-own agreement. As part of the contract, the seller agrees to hold a designated amount of money of each rent payment to go toward the buyer's equity in the property when they purchase it in the future. Instead of a typical down payment of around 20% of the property's purchase price and paid to the mortgage lender, the buyer pays a one-time option-to-buy fee, which is typically 3% to 5% of the purchase price and paid to the seller. There are many issues with this model, as a consumer may pay upfront fees and higher monthly payments than if they were renting. The option-to-buy fee is not refundable if the buyer opts not to buy the property. In some situations, if a consumer misses a payment, the whole deal is off. In other cases, a consumer may discover that at the end they are locked into paying more than the property is actually worth, or that they can't qualify for a mortgage to finish paying off the property. In a rent-to-own arrangement, payments and fees are generally fixed, calculated in advance and the payments terms are inflexible and static.

Lease-to-own is similar to rent-to-own. During the term of the option, the buyer agrees to lease the property from the seller for a predetermined rental amount. The option money generally does not apply toward the down payment, but a portion of the monthly lease payment goes toward the purchase price. The key difference, however, is that rent-to-own offers an option to buy, while a lease-to-own purchase may obligate the tenant to buy. In Lease-to-own payments and fees are generally also fixed and calculated in advance. These payments terms are inflexible and static. Furthermore, the buyer is obligated to make the final lumpsum payment to buy the property without any alternate option.

Co-living is a form of communal living in which a plurality of residents share a multi-bedroom or multi-apartment property with private areas and shared common areas. Co-living is popular in major cities as a means of affordable living for students, nomad workers, or individuals relocating and wanting to experience the new city with built-in interaction with strangers. Co-living can be attractive to consumers due to affordability, flexibility, included amenities, and a sense of community. The consumers in the co-living agreement do not own the real estate property but merely rent it on a collective basis with each individual having the flexibility to move out as and when needed. Co-living currently provides no means for the consumer to establish an equity investment in the real estate owned by the Co-living companies. In a co-living arrangement monthly payments may be flexible or fixed, and can be calculated in advance but also on a month-to-month basis. Although the term of stay is flexible, this arrangement does not offer any opportunity for ownership or financial growth opportunity.

A co-op, short for “cooperative,” is a housing arrangement where a plurality of participants own shares of a corporation that in turn owns all of the property in the cooperative. As a part-owner of the company these owners may have the right to live on the premises. Typically, participants in a co-op get locked into a single property and are usually obligated to take on certain property management duties. Co-ops can often be governed by stricter rules than are condominiums, with restrictions on subletting, on admission criteria, or on parents purchasing for their children. Co-op boards wield an inordinate amount of control and influence over members' lives. There may also be stricter rules for financing as a co-op association may accept very little loan financing or none at all. Buyers are subject to intense financial scrutiny when applying to buy into a co-op, making it more difficult to buy and even harder to sell co-op shares, since a seller may invest time and resources to find a buyer, only to have the co-op board reject the buyer. Thus, the co-op model has many shortcomings that restrict it from mass adoption. In a co-op arrangement, monthly payments are generally fixed and calculated in advance, not changing from month-to-month or providing any flexibility. These payment terms do not reflect the changes in the market nor offer any opportunity to amend the payment structure.

A timeshare is a mechanism where a plurality of buyers shares the occupancy of a property, usually a vacation property located in a resort. Each buyer usually purchases a certain period of time in a particular unit. The minimum purchase is a one-week ownership, and the high-season weeks demand higher prices. Units may be sold as a partial ownership deed, but more often as shares in a holding company with a lease provision or a “right to use”, in which case the purchaser holds no real claim to ownership of the property. With right-to-use contracts, a purchaser has the right to use the property in accordance with the contract, but at some specified point in time the contract ends and all rights revert to the property owner. A timeshare can be suitable for vacations but is not a suitable ownership mechanism for a principal residence. In addition to issues related to rights, timeshares become prohibitively expensive to own for more than a few weeks a year. In a timeshare payments are primarily annual maintenance fees which are fixed and additional costs may apply on a pay-as-use basis. This arrangement does not offer any opportunity for ownership or financial growth.

A Real Estate Investment Trust (REIT) is a company that owns, and in most cases operates, income-producing real estate. REITs can be publicly traded on major exchanges, publicly registered but non-listed, or private. Depending on their types, individuals or other companies can buy shares in a REIT. Buying shares in a REIT does not include any occupancy rights. An investor may choose to rent in a REIT-controlled building as an independent decision to the investment in shares, but there is no relation between the two and no path to get on the real estate owner-occupancy ladder. In REIT monthly payments are generally fixed and calculated in advance. The payments or payment terms do not change month-to-month, thus not offering any flexibility. These payments do not reflect the changes in the market and do not offer any opportunity to make changes to the payment structure.

In a fractional ownership arrangement, a number of participants get together to buy fractions of a real estate property. In most cases to date, fractional purchases provide pro-rata share of the real estate but no occupancy rights (passive investment in residential towers, hotels, commercial properties, etc.). In single family or multi-family residential markets, fractional ownership can come with the right to use the property in proportion to the fraction of ownership. This is an emerging model for the sharing of three- or four-bedroom properties, but not well developed for multi-residential buildings. Rights and obligations are sometimes opaque, specifically around share of ongoing expenses and capital budgets, resale rights and the like. Fractional ownership may be associated with crowdfunding programs or security token offerings, both methods of finance being nascent. Fractional ownership suffers from all the issues typically associated with traditional real estate, with new issues related to ongoing capitalization and governance.

The prior art ownership models discussed above require for their implementation, legal and financial transactions between various entities, such as consumers, financial institutions, local property management and third-party service providers (e.g., cleaning services, moving services, child care services, pet care services, etc.). However, according to prior art ownership models such transactions between entities are disparate and asynchronous. Although, computer systems may be implemented within each of these entities, such as consumer devices transacting with financial institution systems and local property management, and with local property management and/or third-party services, a technological problem exists in integrating and automating such transactions to provide an ownership mechanism for consumers to easily occupy a property or move from one property to another without incurring buy/sell costs, with proper governance, while maintaining and growing a related equity investment. For example, prior art ownership models do not provide any method for communicating to an owner-resident their payment obligations that are dynamic and changing over time.

The description above is presented as a general overview of related art in this field and should not be construed as an admission that any of the information it contains constitutes prior art against the present patent application.

### SUMMARY

According to an aspect of this disclosure, a network-based OMS is provided for integrating and automating financial and legal transactions between disparate entities, such as consumers, financial institutions, local property management and third-party service providers (e.g., cleaning services, moving services, child care services, pet care services, etc.), so as to establish an ownership mechanism for consumers to easily occupy a property or move from one property to another without incurring buy/sell costs, with proper governance, while maintaining and growing a related equity investment. The established ownership mechanism differs from traditional real estate ownership and is characterized by the following features: title-less ownership with occupancy rights, wholly electronic ownership management, low minimum investment, no mortgage or other form of personal debt, no real estate broker commissions, or other expenses to pay when buying or selling, no lawyers or inspectors or stagers to deal with or pay, and the ability to easily change occupancy from one property to another with an equity investment that is fully portable.

The OMS as set forth herein includes one or more computer servers configured to coordinate transactions between such disparate entities, including at least one consumer and one or more local property management servers (LPMS). An example method may be implemented by the OMS for creating and maintaining a consumer profile, establishing bidirectional communication between a requesting consumer and the OMS and obtaining, for example via a graphical user interface operable on a device of the consumer, preferences concerning property ownership at a desired location, property type, size and living arrangements, and a request from the consumer for property ownership. The OMS can then search for properties available via the LPMS that match the consumer preferences, and upon consumer selection of a desired property enable a financial transaction and an ownership and occupancy change transaction and record that in the OMS. The OMS can then provide a confirmation to the consumer regarding completion of the financial transaction and ownership rights and occupancy rights on a part-ownership basis along with a date and time for the requesting consumer to move into the property.

The OMS also preferably includes a user interface configured to provide information to local personnel associated with a local property through the LPMS at the location of the consumer selected property, regarding change in ownership along with date and time of start of occupancy and date and time of consumer move into the property if the two are different.

The OMS and/or LPMS may preferably be in communication with one or more third party service providers such as a moving company, cleaning services company, child care company, pet care company, etc., and configured to display these third party service providers to the consumer preferably along with their charges, and engage desired third party service providers upon receiving a request from the consumer, including providing notifications detailing date and time and other preferences to the consumer, and conducting a financial transaction by deducting funds from the consumer's account at a financial institution, transferring funds to the selected third party's account after the completion of the service and preferably retaining a portion of the funds for facilitating and supervising the engagements.

In accordance with another aspect of this disclosure, the OMS preferably includes a contractual obligation engine (COE) for creating a computer-implemented synthetic form of co-ownership with occupancy rights, and for providing automated communication to an owner-resident of payment obligations that are dynamic and changing over time (e.g., automated reductions in monthly payments with increased equity based on value of the property). In an aspect, the COE calculates the value of a property on a regular periodic basis, establishing the synthetic co-ownership interest for the owner-resident, attaching rights and obligations to that interest, porting the interest seamlessly between properties, adjusting the interest up or down with minimal steps on a regular periodic basis, calculating financial obligations associated with residency on a regular periodic basis with a proprietary formula for residency payment as a function of the co-ownership interest and the calculated value of the property, and automating legal and financial transactions associated with maintaining residency payments and in response increasing or decreasing co-ownership interest. The network-based system integrates several platform services to provide automation and speed of service.

The secure administration of the COE requires the use of computer technology and network connections that are not available through existing ownership models, including identity verification, access to financial accounts and instruments, and digital execution of contracts facilitated by a key system to securely validate and assure the owner-resident has continual access to the property via the OMS.

The COE as set forth herein provides an owner-resident access to equity growth and occupancy rights available through traditional title ownership without traditional barriers to access for title and with a highly simplified process that removes time, cost, and intermediaries.

In an embodiment, the COE computes a suite-based contractual obligation and preferably saves it to a database in the OMS.

In another embodiment, the COE computes an EVA (equity value adjustment), which is the difference between the suite Market contractual obligation and the suite-based contractual obligation and preferably saves it in a database in the OMS.

In another embodiment, the COE aggregates a total suite-based equity value adjustment, which is the sum of all suite-based equity value adjustments, and preferably saves this value in a database in the OMS.

In another embodiment, the COE aggregates a total portfolio equity which is the sum of all suite's owner's equity and the total investors' equity and stores it preferably in a database in the OMS.

In another embodiment, the COE computes the equalization of profit for all stakeholders: i.e. owner-residents and non-resident investors, for example to provide the same financial return on their investment in the ODRE, and stores it preferably in a database in the OMS.

In another embodiment, the COE computes a portfolio-based equity value adjustment and stores it preferably in a database in the OMS.

In another embodiment, the COE computes the contractual obligation adjustment factor, which is the difference between suite-based equity value adjustment and portfolio-based equity value adjustment and preferably saves it in a database in the OMS that stores related information.

In another embodiment, the COE computes the portfolio-based contractual obligation, which is the sum of suite-based contractual obligation and contractual obligation adjustment factor and preferably saves it to a database in the OMS that stores related information.

In another embodiment, the COE may use a linear relationship graph for computing its different values. In other embodiments of the invention the contractual obligation engine may use parabolic, quadratic, hyperbolic logarithmic or other kind of relationship graphs for computing various methods of calculating our results.

In another embodiment, contractual obligation may also be referred to with various other terms e.g. monthly payment, buydown, rent reduction or the like.

In another embodiment, the “adjustment factor” may be conveyed to the owner-resident in the form of cash, gift card, loyalty points, reduction in fees/expenses/costs, dividends, or other forms in one or different combinations of the aforementioned.

In another embodiment, the COE sources of input variable may be composed of one or more combinations of local, regional and/or global variables when computing the various factors.

An aspect of the disclosure provides a property ownership management system, comprising: at least one local property management server; a first interface for communicating with at least one consumer via a consumer device; a second interface for communicating with at least one financial institution using secure communications; a third interface for communicating with the at least one local property management server; at least one central server configured to receive via the first interface a consumer request to purchase ownership of a property characterized by consumer preferences selected by filtering property criteria including one or more of a desired location, move in date, alternate move in date, property type, size and living arrangements, search an availability database for any available property according to the filtered property criteria for matching the selected consumer preferences, transmit via the first interface at least one property proposal to the consumer device, wherein the property proposal matches at least one of the filtered property criteria, generate via the consumer device a reservation request to reserve the at least one property proposal, including financial data in support of the reservation request, receive the reservation request via the first interface, transmit via the second interface a financial transaction request and the financial data to the at least one financial institution to secure consumer funds, receive via the second interface consumer funds from the at least one financial institution to complete the financial transaction, create a contract for recording occupancy rights, equity in the reserved property and the financial transaction, update the availability database to remove availability of the reserved property, transmit to the consumer via the first interface confirmation of the contract and notification of a date of occupancy start, and transmit to the at least one local property management server via the third interface notification regarding change of ownership of the reserved property and move in date.

Another aspect of the disclosure provides a contractual obligation engine, comprising: a calculator module; a suite value module for processing property value; a database pointing to an equity table for maintaining one or more of consumer equity position values and payment obligations; and a payment gateway,

wherein the calculator module is configured to receive a monthly contractual payment obligation value for a property from the database, receive a base payment value from the database representing costs associated with operating the property, receive a payment benefit coefficient from the database representing consumer percent equity in the value of the property, calculate an additional payment value by multiplying the difference between the monthly contractual payment obligation value and the base payment value by the payment benefit coefficient, and generate a suite-based contractual obligation value payable by the consumer, by summing the base payment value and additional payment value, such that the suite-based contractual obligation value represents a discount of the monthly contractual payment obligation value by a suite-based equity value adjustment related to the payment benefit coefficient.

The details of one or more variations of the subject matter described herein are set forth in the accompanying drawings and the description below. Other features and advantages of the subject matter described herein will be apparent from the description and drawings.

### DESCRIPTION OF DRAWINGS

FIG. 1A is a block diagram of a system for on-demand property ownership, in accordance with an example of the present disclosure.

FIG. 1B is a block diagram of the system of FIG. 1A implemented over a portfolio of properties according to one possible example of the present disclosure.

FIG. 2A is a flowchart showing a method implemented by the system of FIG. 1A for facilitating a consumer financial and ownership transaction, according to an embodiment.

FIG. 2B is a functional diagram of the system of FIG. 1A for onboarding a new consumer according to the method of FIG. 2A.

FIG. 3 is a flowchart showing a method implemented by the system of FIG. 1A for facilitating a consumer financial and ownership transaction, according to an additional embodiment.

FIG. 4 is a flowchart showing a method implemented by the system of FIG. 1A for facilitating a consumer financial and ownership transaction, according to an additional embodiment.

FIG. 5 is a flowchart showing a method implemented by the system of FIG. 1A for facilitating a consumer financial and ownership transaction, according to an additional embodiment.

FIG. 6 is a flowchart showing a method implemented by the system of FIG. 1A for facilitating a consumer financial and ownership transaction, according to an additional embodiment.

FIG. 7 is a block diagram of a contractual obligation engine (COE), according to an embodiment.

FIG. 8 is a flowchart showing a method implemented by the COE of FIG. 7 for calculating a suite-based contractual obligation, according to an embodiment.

FIG. 9 is a flowchart showing a method implemented by the COE of FIG. 7 for calculating a suite-based equity value adjustment.

FIG. 10 is a flowchart showing a method implemented by the COE of FIG. 7 for calculating a total all-suite-based equity adjustment value representing an aggregate payment benefit for all equity owners of a portfolio of properties.

FIG. 11 is a flowchart showing a method implemented by the COE of FIG. 7 for calculating total portfolio equity for the portfolio of properties.

FIG. 12 is a flowchart showing a method implemented by the COE of FIG. 7 for calculating a portfolio-based equity adjustment value.

FIG. 13 is a flowchart showing a method implemented by the COE of FIG. 7 for calculating a contractual obligation adjustment factor.

FIG. 14 is a flowchart showing a method implemented by the COE of FIG. 7 for calculating a portfolio-based contractual obligation value.

FIG. 15 is a graph showing a relationship between portfolio payment reduction and pledged portfolio equity, according to an example.

FIG. 16, which includes FIGS. 16A and 16B, is a graph showing a relationship between obligated consumer payments and pledged equity without equity value adjustment (FIG. 16A) and with equity value adjustment (FIG. 16B), according to an example.

### DETAILED DESCRIPTION

Before embodiments of the invention are explained in detail, it is to be understood that the invention is not limited in its application to the details of the examples set forth in the following descriptions or illustrated drawings. It will be appreciated that numerous specific details are set forth to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein.

Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

In this description and in the drawings, ODRE denotes property in the form of on-demand real estate administered by the ownership management system (OMS) set forth herein, and COE denotes a contractual property engine of the OMS. Also, in connection with describing the COE, references to “suite” denotes an ODRE property within a building, such as a high rise or midrise building at a location.

Computer program code for carrying out operations of the present invention may be written in any combination of one or more programming languages, including in object-oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviors that other programming languages might perform during compilation. JavaScript, TypeScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU or GPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example, and without limitation, the programmable computers may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on a standalone computer, a server, a server farm, virtual machines, cloud computing, on the mobile device as a stand-alone software package, partly on the mobile device and partly on a remote computer or remote computing device or entirely on the remote computer or server or computing device. In the latter scenario, the remote computers may be connected to each other or the mobile devices through any type of network, including a local area network (LAN) or a wide area network (WAN), or the connection may be made to the internet through a mobile operator network (e.g., a cellular network); WiFi, Bluetooth, etc.

The servers and processors may be physical or virtual e.g., implemented in a cloud architecture. The processing may be accomplished using a Central Processing Unit (CPU) or a Graphic Processing Unit (GPU).

Modern GPUs are very efficient at manipulating computer graphics and image processing. Their highly parallel structure makes them more efficient than general-purpose Central Processing Units (CPUs) for algorithms that process large blocks of data in parallel.

Architecturally, the CPU is composed of just a few cores with lots of cache memory that can handle a few software threads at a time. In contrast, a GPU is composed of hundreds of cores that can handle thousands of threads simultaneously. The ability of a GPU with 100 plus cores to process thousands of threads can accelerate computation requiring parallel processing. Additionally, a GPU may achieve this acceleration while being more power- and cost-efficient than a CPU.

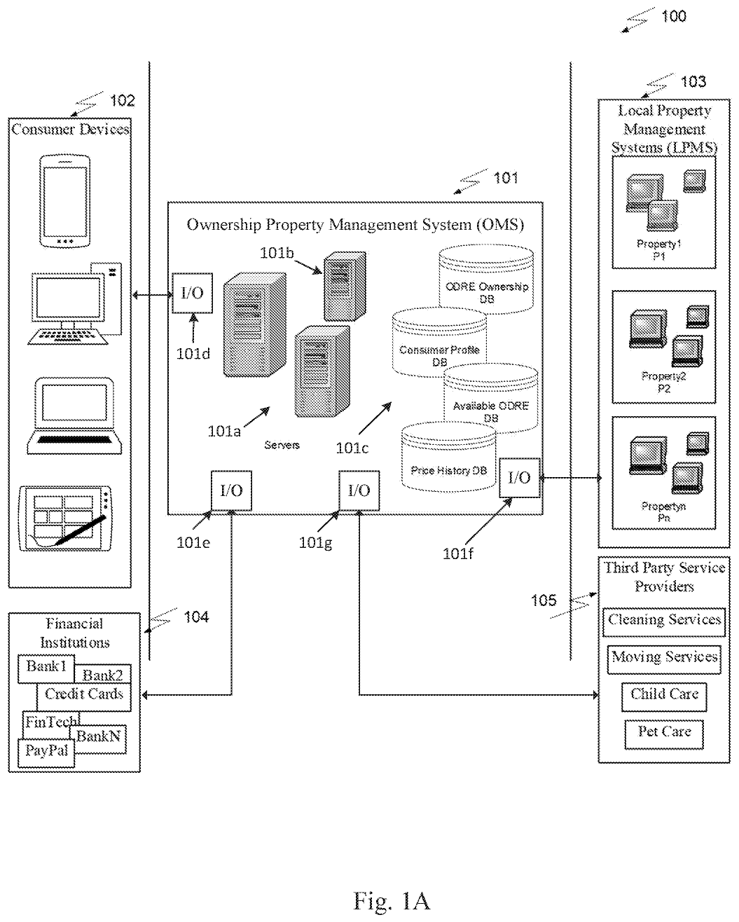

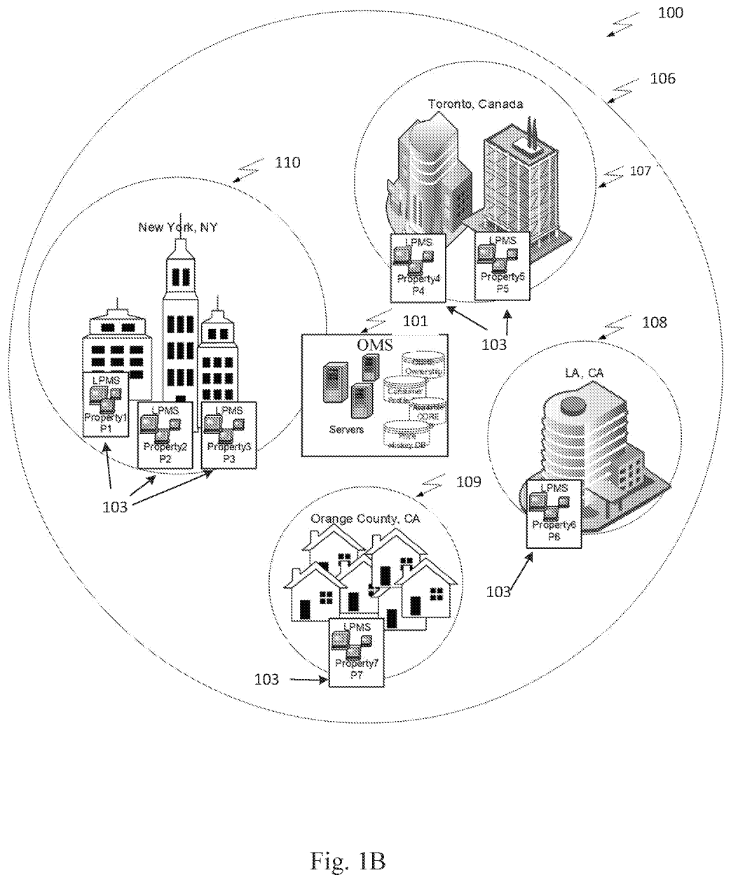

Turning now to FIG. 1, a system 100 for on-demand property ownership is depicted, in accordance with an example embodiment, including a network-based OMS 101, including one or more computer central servers 101a, at least one of which is configures as a contractual obligation engine (COE) 101b, as a and at least one database (DB) 101c, for integrating and automating financial and legal transactions between consumer devices 102 via a first interface 101d, financial institutions 104 (e.g., banks, credit card companies, PayPal and the like) via a second interface 101e, local property management servers (LPMS) 103 via a third interface 101f, and third-party service providers 105 via a fourth interface 101g, so as to establish an ownership mechanism for consumers to easily occupy a property or move from one property to another without incurring buy/sell costs, with proper governance, while maintaining and growing a related equity investment.

Consumer devices 102 may include but are not limited to Smartphones, computers, laptops, desktops, tablet computers, iPad and the like,

Third-party service providers 105 may include cleaning service companies, childcare companies, pet care companies, moving companies, grocery companies, etc.

The OMS 101 may preferably manage one or more real estate properties e.g. condominium suites located in one or more different physical locations depicted by Property1 P1, Property2 P2 and Property3 P3, and or all of which can be a high rise buildings with multiple residential units in each, or a set of midrise residential units, or a collection of townhomes, or a collection of semi-detached or detached single homes, and any combination thereof. The invention is not limited to these property types and this list is exemplary and not limiting.

The OMS 101 may preferably be configured to remotely connect to one or more Local Property Management servers (LPMS) 103. The LPMS 103 may be further configured to manage the various aspects of the real estate properties e.g. access control to the property and associated units, key authorizations, maintenance and care of the real estate building, and to provide information to local personnel associated with a local property through the LPMSs 103 regarding change in ownership along with date and time of start of occupancy and date and time of consumer move as well as provisioning of any consumer selected third party services 105, such as cleaning service companies, childcare companies, pet care companies, moving companies, grocery companies, etc.

OMS 101 includes a first user interface configured to gather property criteria from a consumer device 102, via a first graphical user interface displayable on the device 102. In another embodiment, the first user interface may be a voice activated interface for gathering consumer property criteria. One or more of the central servers 101a may be configured to search available properties in an availability database such as Available ODRE (On-Demand Real Estate) DB 101c that match the consumer criteria at desired location (P1, P2 . . . Pn).

One or more of the servers central 101a periodically poll the multiple LPMSs 103 at respective locations (P1, P2 . . . Pn), to maintain current availability data in the Available ODRE DB 101c. Alternatively the respective LPMSs 103 may be programmed to push updated availability data to the Available ODRE DB 101c in response to a change in local occupancy.

One or more of the central servers 101a may be configured for completing, upon consumer selection of a desired property to occupy, a financial transaction and an ownership change transaction and recording the same in an ODRE Ownership DB 101c, and to provide a confirmation to the consumer regarding completion of the financial and ownership transactions and ownership rights and occupancy rights associated with the property.

The OMS 101 and/or the LPMS 103 may preferably be in communication with one or more third party service providers 105, for example at least one moving company, at least one cleaning services company, at least one child care company, at least one pet care company, at least one grocery company, and to display these third party service providers preferably along with their charges, as well as engage desired third party service providers upon receiving a request from the consumer, and provide notifications detailing date and time and other preferences to the consumer, selected third parties and local management personnel, and to conduct a financial transaction by deducting funds from the consumer account, transferring funds to the selected third party's account after the completion of the service and retain a portion of the funds for facilitating and supervising the engagements.

FIG. 1B is a block diagram of the on-demand property ownership system 100 according to FIG. 1A implemented over a portfolio 106 of properties, according to one possible example of the present disclosure, comprising multiple properties 107, 108, 109 and 110 in different cities, wherein each property may be composed of one or multiple suites, and wherein OMS 101 manages the ownership rights and occupancy rights associated therewith. In the illustrated example, properties 107 in a first city e.g., Toronto, Canada, may be composed of two high-rise buildings with multiple suits/units in each building having a dedicated LPMS associated with property, property 108 in a second city e.g., Los Angeles, Calif. USA, may be composed of one midrise building with multiple suits in the building having its own dedicated LPMS, properties 109 in a third city e.g., Orange County, Calif. USA, may be composed of multiple single-family homes that collectively share a dedicated LPMS, and properties 110 in a fourth city e.g., New York, N.Y. USA, may be composed of multiple high-rise and midrise buildings with multiple suits in each building and having a dedicated LPMS 103. Alternatively, rather than having a dedicated LPMS 103 associated with each property 107, 108, 109 and 110, it is contemplated that a centralized LPMS may collectively service all of the multi-suite buildings in a given city or region.

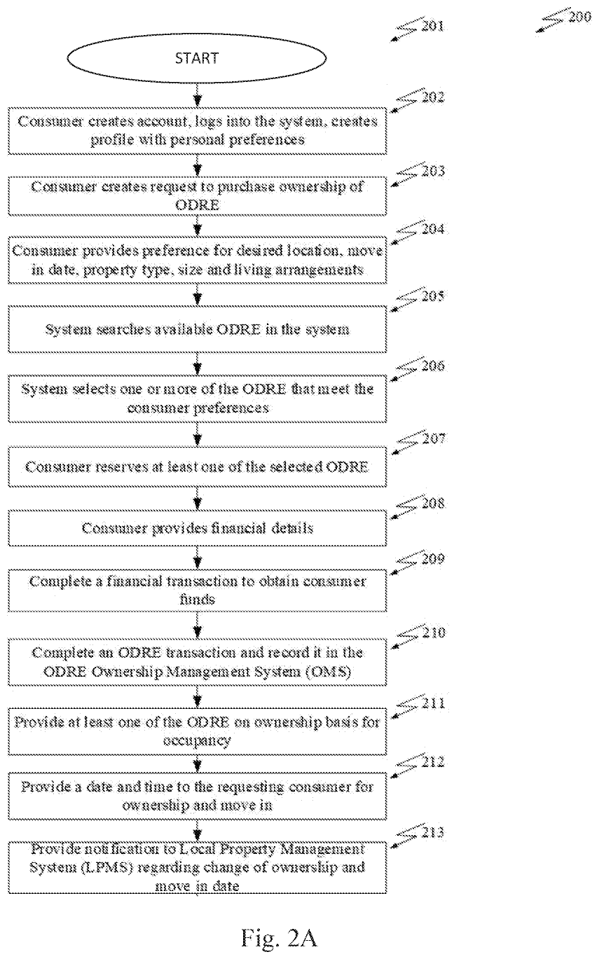

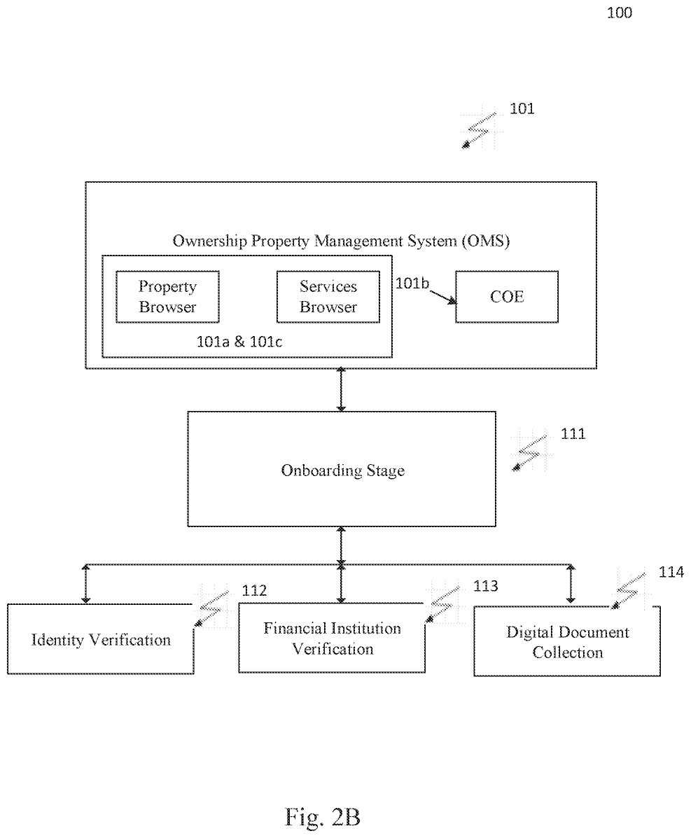

FIG. 2 is a flowchart showing a method 200 implemented by OMS 101 for facilitating a consumer financial and ownership transaction, according to an embodiment. At least one of the servers 101a begins execution of the method at 201.

At 202, a consumer using a consumer device 102 communicates with a central server 101a of the OMS 101 via first interface 101d to create an account, log into the OMS 101, and create a profile with personal preferences, collectively referred to herein as onboarding.

Turning briefly to FIG. 2B, a functional diagram of the system of FIG. 1A is provided for onboarding a new consumer at 202. Functionally, OMS 101 includes central servers 101a, contractual obligation engine (COE) 101b, and databases (DB) 101c, for integrating and automating financial and legal transactions between consumer devices 102 via a first interface 101d, financial institutions 104 (e.g., banks, credit card companies, PayPal and the like) via a second interface 101e, local property management servers (LPMS) 103 via a third interface 101f, and third-party service providers 105 via a fourth interface 101g. However, before a consumer can utilize the OMS functionality, the consumer must first be onboarded. The onboarding stage at 202 is a prerequisite to providing a user access to the OMS 101 and in particular access to select, change and move properties while retaining equity and ownership rights. As shown in FIG. 2B, onboarding stage 111, which may be external to the OMS 101 or incorporated into central server 101a, and uses an identity verification module 112, which can be an identity certification API, to facilitate communication with the consumer via the first interface 101d for taking a user identity photograph, ID match (e.g. driver's license, passport, etc.), a financial institution verification module, which can be an financial authorization APIs such as Vopay™ or Plaid™, to facilitate communication with the financial institutions 104 via the second interface 101e.

Returning to FIG. 2A, the onboarding data may then be stored in a Consumer Profile DB 101c. In one embodiment, the onboarding process at 202 creates an account with the OMS 101 including username, password, two-factor authentication login data, legal first and last names, residence address, date of birth, verification document (e.g., one or more of government issued driver's license, passport, health card, etc.), financial institution authorization security links, employment and annual income, amongst other personal information and optional personal preferences.

Once the user has logged in to the OMS 101 by entering username and password, then at 203, the consumer creates request to purchase ownership of a property. In one embodiment, the consumer may preferably use a graphical user interface provided by the OMS 101, while in other embodiments the consumer may use a voice activated system under control of the server that recognizes and responds to verbal commands from the consumer.

At 204, the consumer provides preferences for desired location, a move in date, property type, size and living arrangements, which are communicated via the graphical user interface or voice activated system. In one embodiment of the invention consumer may provide a preference for desired location, a preferred move in date and or alternate move in date, property type e.g., apartment, one story, two story, etc. size, e.g., 1200 square feet and living arrangements e.g., 2 bedrooms and 2 washrooms or 3 bedrooms, 2 washrooms and a powder room etc.

Accordingly, the consumer request to purchase ownership of a property is characterized by consumer preferences selected by filtering property criteria including one or more of a desired location, move in date, alternate move in date, property type, size and living arrangements.

The central server 101a of the OMS 101 receives the consumer request via the first interface 101d, and in response searches an Available ODRE DB at 205 for any available property according to the filtered property criteria for matching the selected consumer preferences.

In one embodiment of the invention system only searches the availability database (Available ODRE) for properties that are currently lying vacant but may also consider what properties may become available in the future given that some consumers may be selling and moving out while others may be moving to a different property.

At 206, the OMS 101 selects one or more of the properties that meet the consumer preferences. The central server 101a of the OMS 101 then transmits via the first interface 101d at least one property proposal to the consumer device 102, wherein the property proposal matches at least one of the filtered property criteria.

In one embodiment, the consumer may only be shown properties that fully match the consumer provided criteria. In another embodiment, the consumer may be shown properties that match some but not necessarily all of the consumer provided criteria. In a further embodiment, if no property in the system fully or partially matches the consumer provided criteria then the consumer may optionally be shown properties that are available or will become available in the future.

At 207, the consumer issues a reservation request to reserve at least one of the selected properties using the graphical user interface or voice activated system and at 208 provides financial details in support of the reservation request such as personal identification, current and previous address(es) over a given time period e.g., last 5 years, banking information, credit history, credit score, country of residence and residency status for taxation purposes.

Upon receipt of the reservation request via the first interface 101d, at 209, OMS 101, via at least one of the servers 101a, communicates with at least one of the financial institutions 104 via second interface 101e to request a financial transaction to secure consumer funds using, for example, secure communications according to PCI data security standards.

Upon approval, OMS 101 receives from the least one of the financial institutions 104 via second interface 101e, the financial transaction to obtain consumer funds, for example, in the form of government backed currencies such as U.S. Dollar (USD), European Euro (EUR), Japanese Yen (JPY), British Pound (GBP), Swiss Franc (CHF), Canadian Dollar (CAD) etc., or cryptocurrencies such as Bitcoin, Litecoin, Ethereum, Zcash, Monero etc., or a combination of transactions made up of one or more paper/digital and/or one or more cryptocurrencies. A financial transaction may be conducted by use of cheque, draft, money ODRE, wire transfer, email transfer, direct deposit etc. The invention may use any one or a combination of several types and is not limited to this exemplary list.

At 210, OMS 101 completes the consumer transaction, including execution of a contract signed by the consumer using, for example an API into a secure digital document application like HelloSign™, and records it in the ODRE Ownership DB 101c, as a written contract, electronic contract stored on a local server or cloud server, or a smart contact, which is a self-enforcing agreement embedded in computer code managed by a blockchain. The code contains a set of rules under which the parties of that smart contract agree to interact with each other. If and when the predefined rules are met, the agreement is automatically enforced. Smart contracts provide mechanisms for efficiently managing tokenized assets and access rights between two or more parties. The underlying values and access rights are stored on the blockchain, which is a transparent, shared ledger, where they are protected from deletion, tampering, and revision. Smart contracts, therefore, provide a public and verifiable way to embed governance rules and business logic in a few lines of code, which can be audited and enforced by the majority consensus of a P2P network.

At 211, OMS 101 allocates at least one property for occupancy on an ownership basis and updates the availability database (Available ODRE DB) 101c to remove availability of the reserved property.

At 212, OMS 101 transmits to the consumer via the first interface 101d confirmation of the smart contract regarding the completion of the financial and ownership transactions and the ownership rights and occupancy rights associated therewith, and notification of a date of occupancy start.

At 213, OMS 101 provides notification to LPMS 103 via the third interface 101f regarding change of ownership and move in date.

In one embodiment, OMS 101 may directly or via the LPMS 103 be in communication with one or more third party service providers 105 and may engage one or more of these third-party services on behalf of the consumer e.g., engaging a moving company to assist the consumer to move to the reserved property and a cleaning service prior to moving into the reserved property. Other third-party services associated with occupancy of the reserved property may include at least one child care company, at least one pet care company, etc. Upon consumer selection of a third-party service, the system engaging desired third-party service providers (i.e. OMS 101 or LPMS 103) is further configured to provide notifications detailing date and time and other preferences to the consumer, selected third parties and local ODRE management personnel associated with the reserved property through the LPMS 103, and also configured to conduct a financial transaction, as discussed at 208 and 209, by deducting funds from the consumer account, transferring funds to the selected third party's account after the completion of the service and preferably retaining a portion of the funds for facilitating and supervising the engagements.

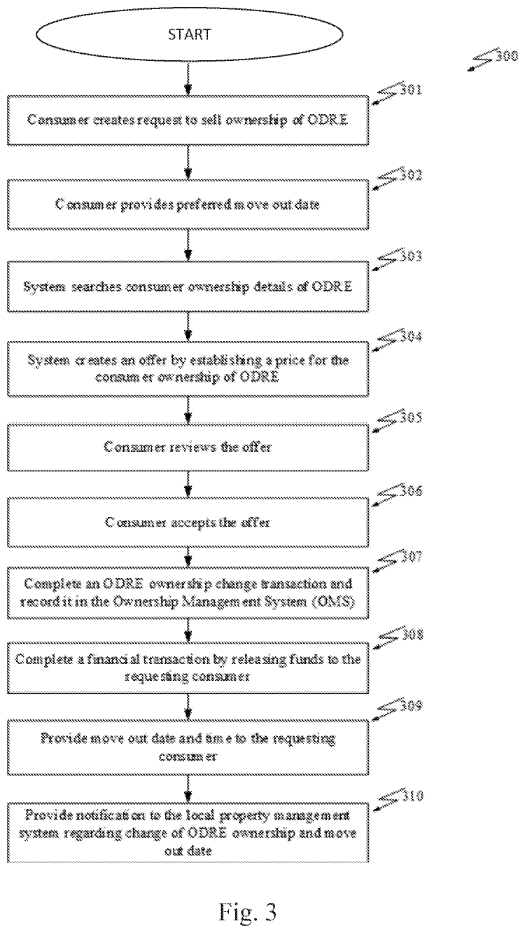

FIG. 3 is a flowchart showing a method implemented by OMS 101 for facilitating a consumer financial and ownership transaction, namely selling ownership of a property, according to an additional embodiment.

At 301, a consumer using a consumer device 102 communicates with a central server 101a of the OMS 101 via the first interface 101d to create a request to sell ownership of a property. In one embodiment, the consumer may preferably use a graphical user interface provided by the OMS 101, while in other embodiments the consumer may use a voice activated system under control of the server that recognizes and responds to verbal commands from the consumer.

At 302, the consumer provides preferences for a move out. In one embodiment, the consumer may be given the option to provide a preferred move out date and an alternative move out date.

The central server 101a of the OMS 101 receives the consumer request via the first interface 101d, and in response at 303, searches consumer ownership details in an ODRE Ownership DB 101c for any smart contract associated with the consumer account. In another embodiment of the invention the system searches consumer ownership details of ODRE in a digital contract associated with the consumer account.

The central server 101a of the OMS 101 creates an offer at 304 by establishing a price for the consumer ownership of the property and transmits the offer to the consumer device 102 via the first interface 101d. In one embodiment, establishing the price may involve Artificial Intelligence (AI) and Machine Learning (ML) techniques.

The consumer reviews the offer at 305, for example using the graphical user interface or another type of user interface e.g. voice, and at 306 accepts the offer, preferably by agreeing to the terms and conditions and digitally signing the contract.

Upon receipt of the accepted offer via the first interface 101d, at 307, OMS 101, via at least one of the servers 101a, completes the ownership change transaction and at records as a smart contact using blockchain technology, as discussed above it in the ODRE Ownership DB 101c.

At 308, OMS 101 completes a financial transaction with a respective one of the financial institutions 104 by releasing funds to the requesting consumer. In one embodiment, OMS 101 stores the details of the financial transaction in the smart contact stored in the ODRE Ownership DB 101c.

At 309, OMS 101 transmits to the consumer via the first interface 101d confirmation of the smart contract regarding the completion of the financial and ownership transactions, and notification of move out date. In one embodiment of the invention the system provides a move out date and time to the requesting consumer.

At 310, OMS 101 provides notification to LPMS 103 via the third interface 101f regarding change of ownership and move out date.

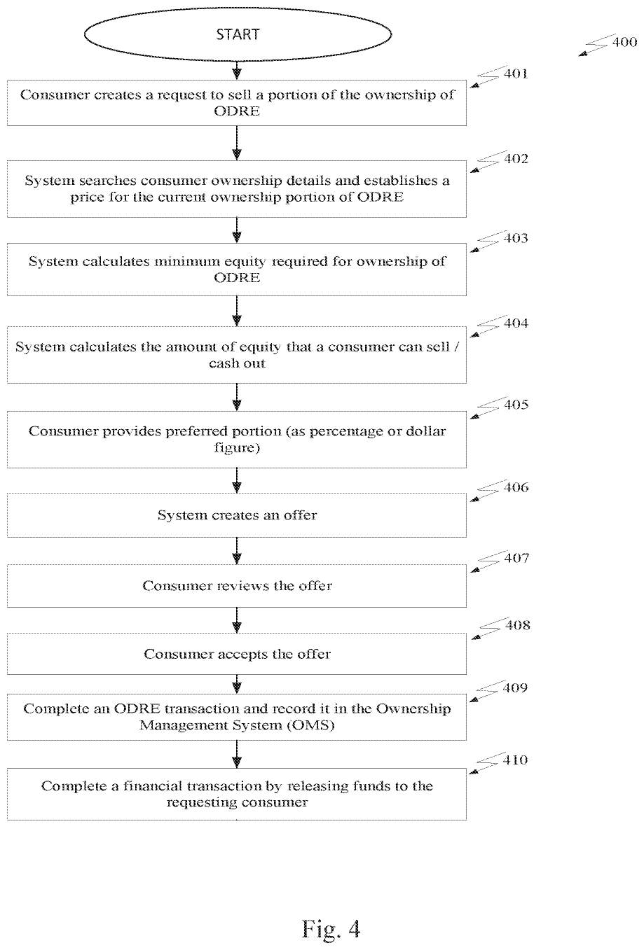

FIG. 4 is a flowchart showing a method implemented by OMS 101 for facilitating a consumer financial and ownership transaction, namely selling a portion of ownership of a property, according to an additional embodiment.

At 401, a consumer using a consumer device 102 communicates with a central server 101a of the OMS 101 via the first interface 101d to create a request to sell a portion of ownership of a property. In one embodiment, the consumer may preferably use a graphical user interface provided by the OMS 101, while in other embodiments the consumer may use a voice activated system under control of the server that recognizes and responds to verbal commands from the consumer.

At 402, OMS 101 searches consumer ownership details in ODRE Ownership DB 101c and establishes a price for the current ownership portion of the property. In one embodiment, OMS 101 searches consumer ownership details preferably in the smart contract associated with the consumer account and establishes a price for the current ownership portion of the property.

At 403, OMS 101 calculates minimum equity required for ownership of the property and at 404 calculates minimum Equity Required for Ownership (ERO) of the property and the amount of equity that a consumer can sell/cash out. In one embodiment, the amount of equity that a consumer can sell/cash out is calculated preferably by subtracting minimum Equity Required for Ownership (ERO) of the property from the price for the current consumer ownership portion of the property.

At 405, the consumer provides a preferred portion (as percentage or dollar figure) of the current ownership that they want to sell/cash out.

The central server 101a of the OMS 101 creates an offer at 406 and transmits the offer to the consumer device 102 via the first interface 101d. In one embodiment, the offer is transmitted in an electronic form e.g. an e-mail with attached electronic documents e.g. PDF versions. While in another embodiment, the consumer may be prompted to log into the OMS 101 and review the offer using the graphical user interface.

The consumer reviews the offer at 407, for example using the graphical user interface or another type of user interface e.g., voice, and at 408 accepts the offer, preferably by agreeing to the terms and conditions and digitally signing the contract. In one embodiment, a time period may be allocated for the consumer to review the offer, while in another embodiment a deadline may be imposed such that if the offer is not reviewed before the deadline the offer expires.

Upon receipt of the accepted offer via the first interface 101d, at 409, OMS 101, via at least one of the servers 101a, completes the ownership change transaction and records it as a smart contact using blockchain technology, as discussed above it in the ODRE Ownership DB 101c.

At 410, OMS 101 completes a financial transaction with a respective one of the financial institutions 104 by releasing funds to the requesting consumer and optionally depositing these funds in the consumer's financial institution of choice. In one embodiment, OMS 101 stores the details of the financial transaction in the smart contact stored in the ODRE Ownership DB 101c.

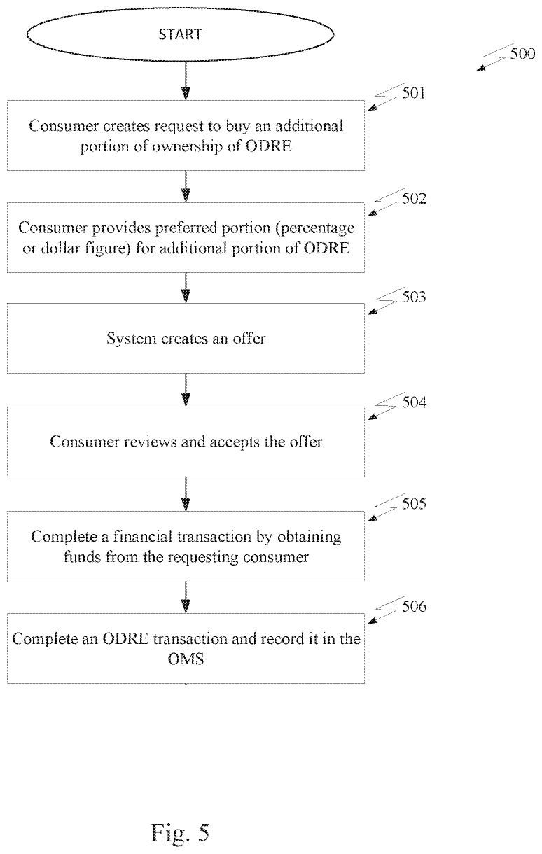

FIG. 5 is a flowchart showing a method implemented by OMS 101 for facilitating a consumer financial and ownership transaction, namely a consumer request to buy an additional portion of ownership of a property.

At 501, a consumer using a consumer device 102 communicates with a central server 101a of the OMS 101 via the first interface 101d to create a request to buy an additional portion of ownership of a property. In one embodiment, the consumer may preferably use a graphical user interface provided by the OMS 101, while in other embodiments the consumer may use a voice activated system under control of the server that recognizes and responds to verbal commands from the consumer.

At 502, the consumer provides a preferred portion (percentage or dollar figure) for the additional portion (e.g. as a percentage or dollar amount).

At 503, the central server 101a of the OMS 101 creates an offer at and transmits the offer to the consumer device 102 via the first interface 101d. In one embodiment, the offer is transmitted in an electronic form e.g. an e-mail with attached electronic documents e.g. PDF versions. While in another embodiment, the consumer may be prompted to log into the OMS 101 and review the offer using the graphical user interface.

The consumer reviews the offer at 504, for example using the graphical user interface or another type of user interface e.g. voice, and accepts the offer, preferably by agreeing to the terms and conditions and digitally signing the contract. In one embodiment, a time period may be allocated for the consumer to accept the offer, while in another embodiment a deadline may be imposed such that if the offer is not accepted before the deadline the offer expires.

Upon receipt of the accepted offer via the first interface 101d, at 505, OMS 101 completes a financial transaction with a respective one of the financial institutions 104 for obtaining funds from the requesting consumer. In one embodiment, OMS 101 stores the details of the financial transaction in the smart contact stored in the ODRE Ownership DB 101c.

At 506, OMS 101 completes the ownership change transaction and records it as a smart contact using blockchain technology, as discussed above, in the ODRE Ownership DB 101c.

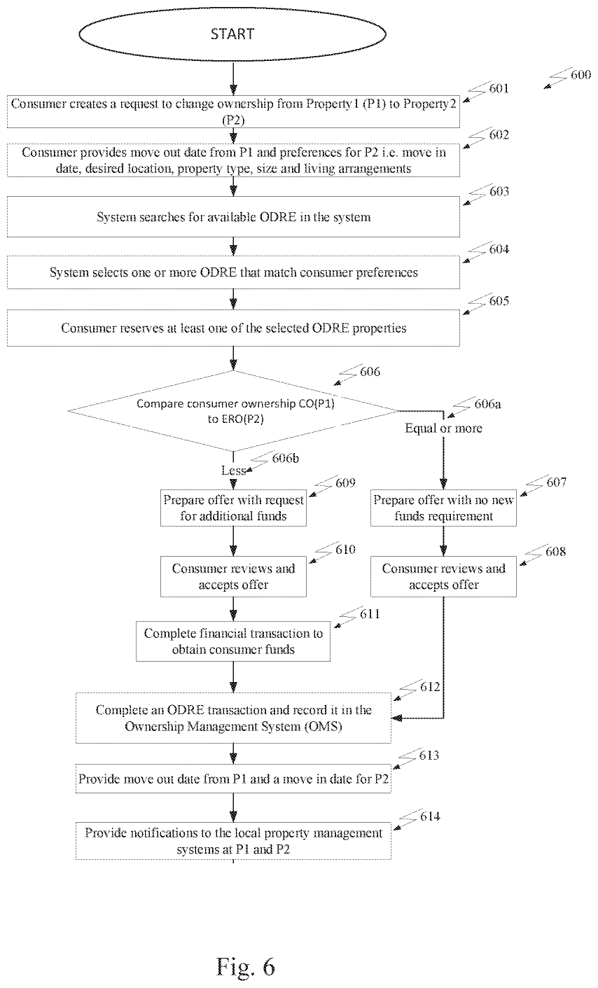

FIG. 6 is a flowchart showing a method implemented by OMS 101 for facilitating a consumer financial and ownership transaction, namely a consumer request to change ownership from a first property (P1) to a second property (P2) and move from the first to the second property.

At 601, a consumer using a consumer device 102 communicates with a central server 101a of the OMS 101 via the first interface 101d to create a request to change ownership from the first property (P1) to the second property (P2). In one embodiment, the consumer may preferably use a graphical user interface provided by the OMS 101, while in other embodiments the consumer may use a voice activated system under control of the server that recognizes and responds to verbal commands from the consumer.

At 602, the consumer provides a move out date from P1 and preferences for a move in date to P2, desired location, property type, size and living arrangements. In one embodiment of the invention consumer provides preferences for P2 including a desired location such as New York City, N.Y., a preferred move in date and or an alternate move in date, property type e.g. apartment, one story, two story, etc. size e.g. 2500 square feet and living arrangements e.g. 4 bedrooms and 3 washrooms or 4 bedrooms, 4 washrooms and a powder room etc.

The central server 101a of the OMS 101 receives the consumer request via the first interface 101d, and in response searches an available ODRE DB at 603 for any available property according to the filtered property criteria for matching the selected consumer preferences.

In one embodiment of the invention system only searches the availability database (Available ODRE) for properties that are currently lying vacant but may also consider what properties may become available in the future given that some consumers may be selling and moving out while others may be moving to a different property.

At 604, the OMS 101 selects one or more of the properties that meet the consumer preferences. The central server 101a of the OMS 101 then transmits via the first interface 101d at least one property proposal to the consumer device 102 for P2, wherein the property proposal matches at least one of the filtered property criteria.

In one embodiment, the consumer may only be shown properties that fully match the consumer provided criteria. In another embodiment, the consumer may be shown properties that match some but not necessarily all of the consumer provided criteria. In a further embodiment, if no property in the system fully or partially matches the consumer provided criteria then the consumer may optionally be shown properties that are available or will become available in the future.

At 605, the consumer issues a reservation request to reserve at least one of the selected P2 properties using the graphical user interface or voice activated system.

Upon receipt of the reservation request via the first interface 101d, at 606, OMS 101, via at least one of the servers 101a, compares consumer ownership CO(P1) to ERO(P2).

If consumer ownership CO(P1) is equal to or more than the ERO(P2) at 606a then at 607 OMS 101 prepares an offer with no new funds requirement, in which case the consumer can move out of property P1 and move into P2 without incurring any costs that are typically associated with buying and selling real estate e.g. agent commissions, land transfer taxes etc.

In an embodiment, OMS 101 may also allow a consumer to cash out some component of their ownership as the consumer owns more equity in ODRE P1 than what is required to move into ODRE P2.

At 608, the consumer reviews and accepts the offer, and the method continues to step 612 which is described below.

If consumer ownership CO(P1) is less than the ERO(P2) at 606b then then at 609 OMS 101 prepares an offer with request for additional consumer funds, since the consumer equity in the ODRE P1 is less than the Equity Required for Ownership in P2.

At 610, the consumer reviews and accepts the offer, for example by agreeing to the terms and conditions and digitally signing the contract. The details of the signed contract may be stored in a smart contact using blockchain technology, as discussed above. In one embodiment of the invention there may be a time period allocated so that the consumer can review the offer before accepting it. While in another embodiment of the invention there may be a deadline such that if the offer is not accepted during this time period the offer expires.

Upon receipt of the accepted offer via the first interface 101d, at 611, OMS 101 completes a financial transaction with a respective one of the financial institutions 104 for obtaining funds from the requesting consumer. In one embodiment, OMS 101 stores the details of the financial transaction in the smart contact stored in the ODRE Ownership DB 101c.

At 612, OMS 101 completes the ownership change transaction and records it as a smart contact using blockchain technology, as discussed above, in the ODRE Ownership DB 101c, and at 613 transmits to the consumer via the first interface 101d confirmation of the smart contract regarding the completion of the financial and ownership transactions and the ownership rights and occupancy rights associated therewith, and notification of a date for moving out of property P1 and of occupancy start for property P2.

At 614, OMS 101 provides notification to LPMS 103 at P1 and P2 via the third interface 101f regarding change of ownership and move in and move out dates.

According to an embodiment, contractual obligation engine (COE) 101b executes processes for computing various variables related to property ownership and propagates the same to owner-residents or the LPMS 103, as discussed below.

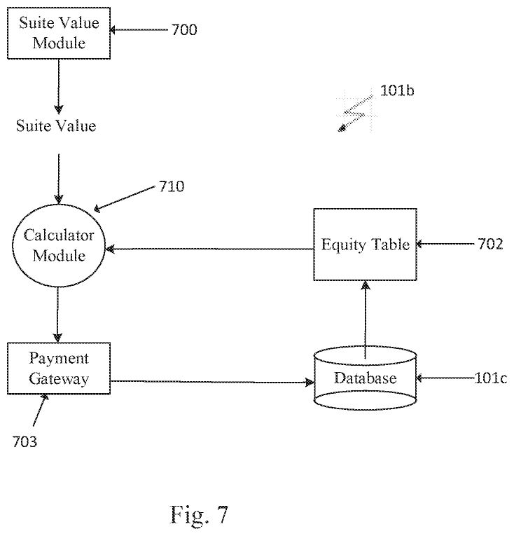

As shown in FIG. 7, COE 101b includes modules for implementing transactions within the OMS 101, including but not limited to establishing a price for consumer ownership of property at 304 and 402, amount of equity that a consumer can sell at 404, minimum equity required for ownership (ERO) in FIG. 6, as well as owner equity, property valuation, contractual obligations amounts, equity value adjustments, property portfolio equity, portfolio-based equity value adjustment value, contractual obligation adjustment factor and portfolio-based contractual obligation value, as discussed below.

The modules COE 101b include a suite value module 700, calculator module 710, equity table 702 and payment gateway 703.

Suite value module 700 can, for example, be a Buildium™ API for processing property value and transmitting the suite value to the calculator module 710.

The equity table 702 is preferably a blockchain operating in conjunction with ODRE Ownership DB 101c, which provides state management for the COE 101b in terms of consumer equity position, payment obligations, etc.

Payment gateway 703 can, for example, be implemented by API access for electronic funds transfer (ETF) via system platforms such as Plaid™ and Vopay™, with required fault tolerance, logging etc., to enable financial transactions such as at steps 308, 410, 505 and 611, discussed above.

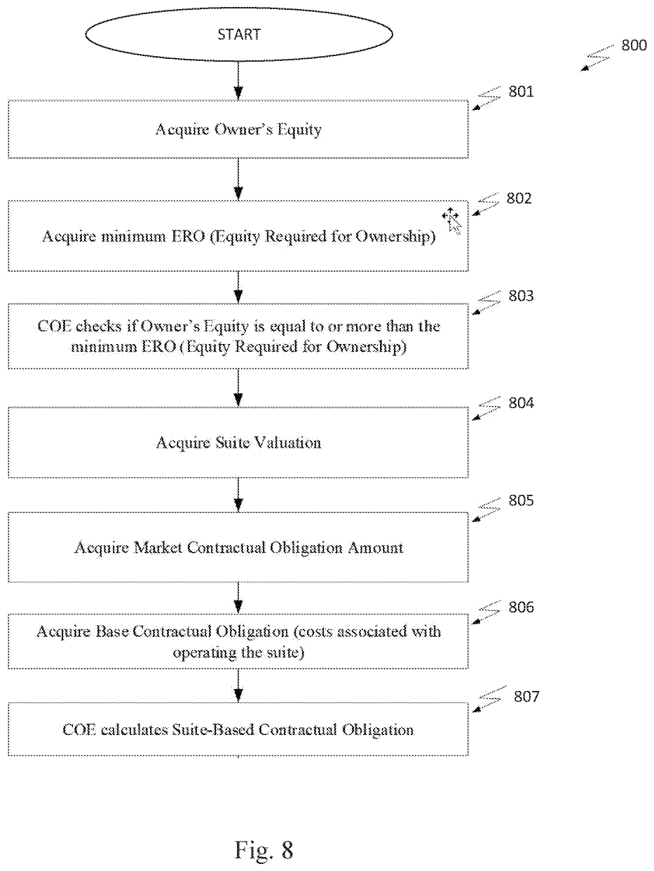

FIG. 8 is a flowchart showing a method 800 implemented by the COE 101b of FIG. 7 for calculating a suite-based contractual obligation value payable by the consumer, according to an embodiment, by summing a base payment value, referred to below as a base contractual obligation, and an additional payment value, referred to below as a market contractual obligation amount, such that the suite-based contractual obligation value represents a discount of the monthly contractual payment obligation value by a suite-based equity value adjustment that is related to a payment benefit coefficient.

At 801, a value for owner's equity is retrieved from blockchain equity table 702 using a pointer from ODRE Ownership DB 101c.

At 802, calculator 710 determines a minimum ERO (equity required for ownership). In one embodiment, the minimum ERO can be obtained from a database in the OMS 101.

At 803, calculator 710 determines if the owner's equity is equal to or more than the minimum ERO. In one embodiment, if owner's equity is less than the minimum ERO the owner is notified and preferably is required to add funds so that owner's equity at least equals ERO.

At 804, the suite value is obtained from suite value module 700.

At 805, calculator 710 receives the market contractual obligation amount from a database 101c in the OMS.

At 806, calculator 710 receives the base contractual obligation value from a database 101c in the OMS, where the base contractual obligation value represents costs associated with operating the suite (property), such as a sum of costs associated with operating the suite in a given building. In one embodiment, all such costs associated with operating the suite and/or the building may be computed in real-time or regular intervals and stored in different databases in the OMS 101. In one embodiment, factors that may impact the costs of operating the suite or the building may be acquired in real-time from relevant third parties and may include but are not limited to future projected values e.g. rates of electricity, gas, taxes etc.

At 807, calculator 710 calculates the suite-based contractual obligation value by summing the base contractual obligation value and the market contractual obligation amount and saves it to a database 101c of the OMS 101.

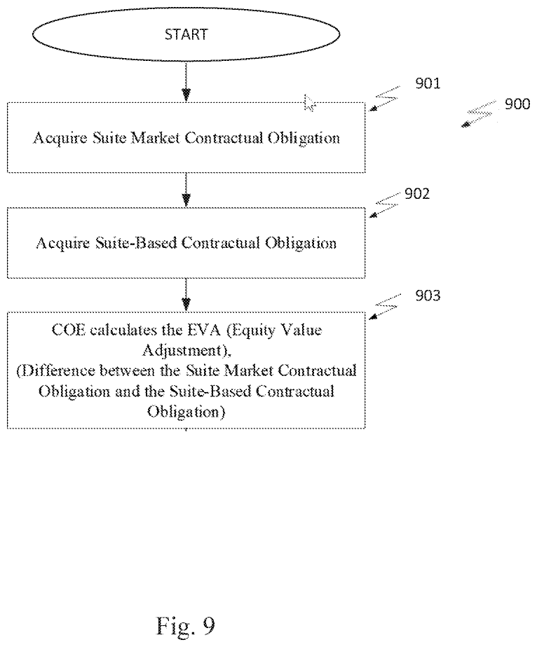

As discussed above, the suite-based contractual obligation value represents a discount of the monthly contractual payment obligation value by a suite-based equity value adjustment that is related to a payment benefit coefficient. FIG. 9 is a flowchart showing a method 900 implemented by the COE 101b of FIG. 7 for calculating the suite-based equity value adjustment.

At 901, a suite market contractual obligation is retrieved from a database 101c of the OMS 101. In an embodiment, the suite market contractual obligation is related to a payment benefit coefficient retrieved from the database representing consumer percent equity in the value of the property

At 902, the calculator 710 retrieves the suite-based contractual obligation value from a database 101c of the OMS.

At 902, the calculator 710 calculates the suite-based equity value adjustment (EVA) by subtracting the suite-based contractual obligation from the suite market contractual obligation value and preferably saves it in a database 101c of the OMS 101.

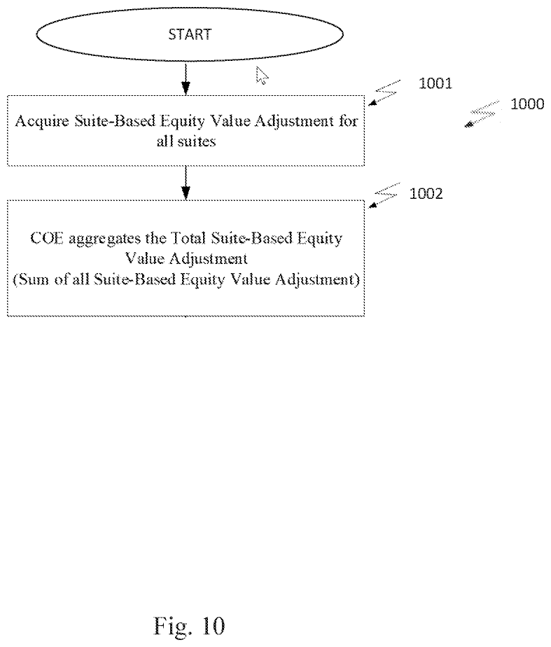

FIG. 10 is a flowchart showing a method 1000 implemented by the COE 101b of FIG. 7 for calculating a total all-suite-based equity adjustment value representing an aggregate payment benefit for all equity owners of a portfolio of properties.

At 1001, the calculator 710 retrieves individual suite-based equity adjustment values for all properties in the portfolio from a database 101c of the OMS and, at 1002, aggregates the individual suite-based equity adjustment values to generate a total suite-based equity adjustment value and stores it in a database 101c of the OMS 101.

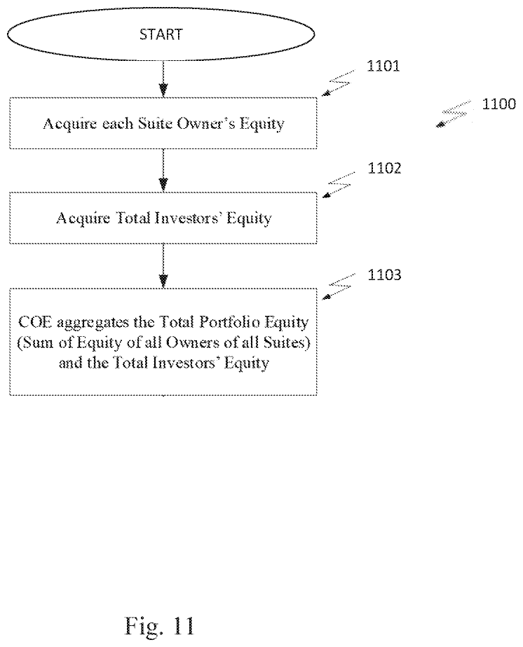

FIG. 11 is a flowchart showing a method 1100 implemented by the COE 101b of FIG. 7 for calculating total portfolio equity for the portfolio of properties.

At 1101, the calculator 710 retrieves each suite owner's equity from suite value module 700 of the COE 101b.

At 1102, the calculator 710 retrieves the total investors' equity from a database 101c of the OMS.

At 1103, the calculator 710 aggregates the total portfolio equity which is the sum of all suite owners' equity and the total investors' equity and preferably saves it in a database 101c of the OMS 101.

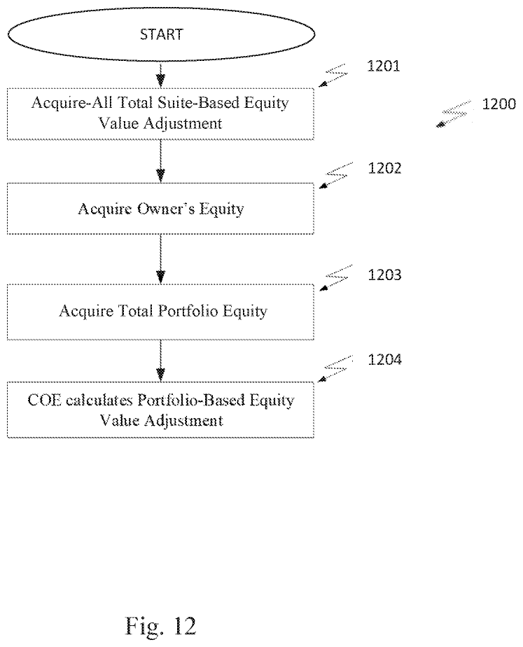

FIG. 12 is a flowchart showing a method 1200 implemented by the COE 101b of FIG. 7 for calculating a portfolio-based equity adjustment value.

At 1201, the calculator 710 retrieves the total suite-based equity adjustment value generated at 1002 of FIG. 10.

At 1202, the calculator 710 retrieves the suite owner's equity from suite value module 700 of the COE 101b.

At 1203, the calculator 710 retrieves the total portfolio equity.

At 1204, calculator 710 calculates a portfolio-based equity adjustment value by multiplying the total all-suite-based equity adjustment value by the total portfolio equity and preferably saves it in a database 101c of the OMS 101.

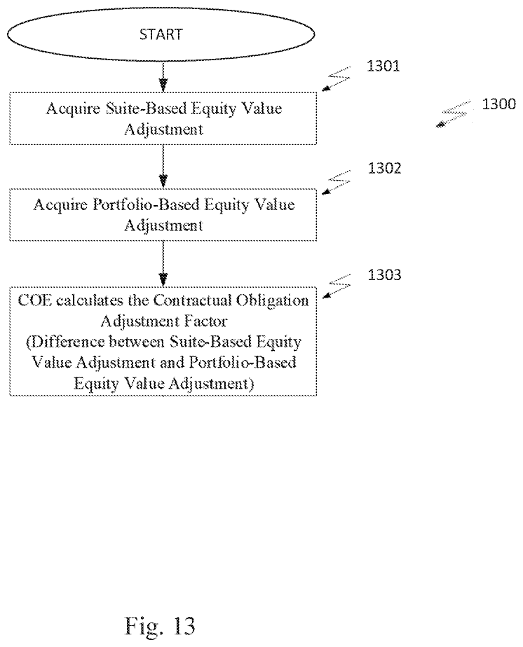

FIG. 13 is a flowchart showing a method 1300 implemented by the COE 101b of FIG. 7 for calculating a contractual obligation adjustment factor.

At 1301, the calculator 710 retrieves the suite-based equity adjustment value generated at 1002 of FIG. 10.

At 1302, the calculator 710 retrieves the portfolio-based equity adjustment value generated at 1204 of FIG. 12.

At 1303, calculator 710 calculates the contractual obligation adjustment factor by subtracting the portfolio-based equity adjustment value from the suite-based equity adjustment value, and preferably saves it in a database 101c of the OMS 101.

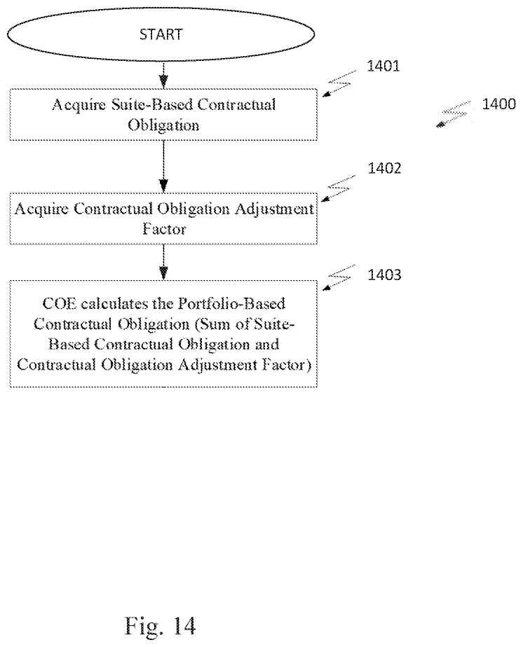

FIG. 14 is a flowchart showing a method 1400 implemented by the COE 101b of FIG. 7 for calculating a portfolio-based contractual obligation value.

At 1401, the calculator 710 retrieves the suite-based contractual obligation value generated at 807 of FIG. 8.

At 1402, the calculator 710 retrieves the contractual obligation adjustment factor generated at 1303 of FIG. 13.

At 1403, calculator 710 calculates the portfolio-based contractual obligation value payable by the consumer by summing the suite-based contractual obligation value and contractual obligation adjustment factor, and preferably saves it in a database 101c of the OMS 101.

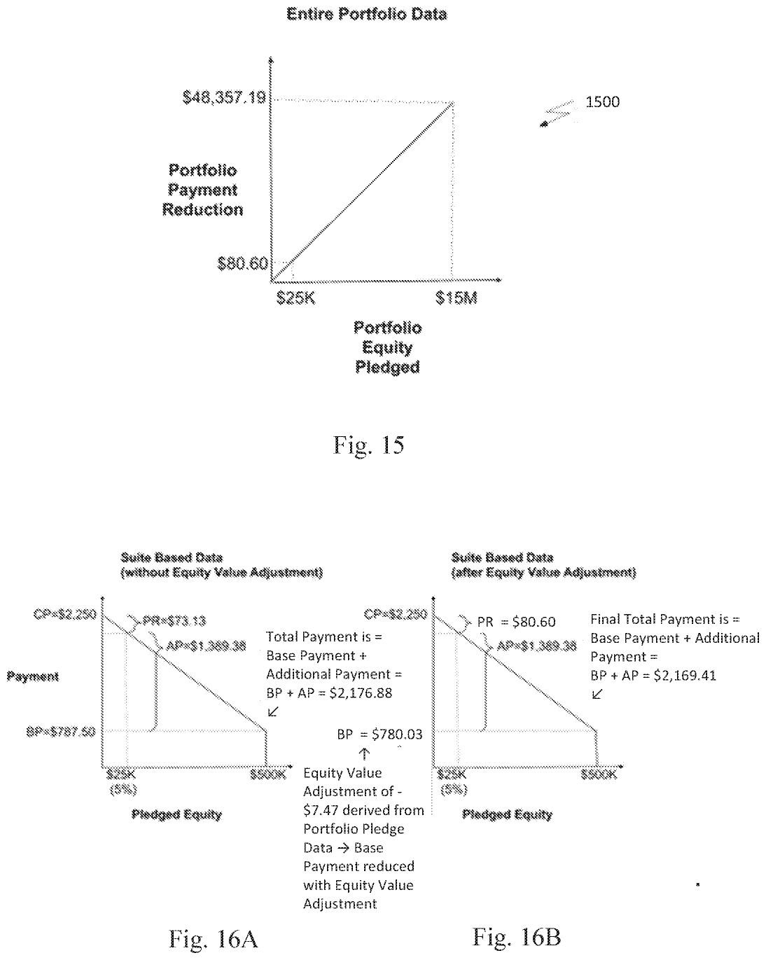

In ODRE to illustrate the operating principles of the COE 101b according to the methods 800, 900, 1000, 1100, 1200, 1300 and 1400, an example is provided, with reference to FIGS. 15 and 16.

In this example, a consumer acquires ownership of a property, for example according to the method 200 set forth in FIG. 2, by pledging $25,000. At the time of her occupancy, the value of the consumer's suite is $500,000, the contractual payment for the suite CP=$2,250 per month, and the costs associated with operating the suite are is: BP_{α,β=0}=$787.5 per month, as depicted in FIG. 16A. Furthermore, there is $15,000,000 in equity pledged across all owner-residents who receive an aggregate payment benefit of $48,357.19 as shown in FIG. 15, which represents the total all-suite-based equity value adjustment discussed with reference to FIG. 10. For simplicity, a minimum income reserve for the suite is α=0.

A payment benefit coefficient for consumer may be calculated as

$$ρ = \frac{\$25 , 000}{\$500 , 000} = 5 \%$$

The additional payment after applying the payment benefit coefficient is: AP=(1−0.05)(2,250−787.5)=$1,389.38.

The suite-based equity value adjustment (FIG. 9) is: Pₛ=$2,250−$1,389.38−$787.5=$73.12

A payment pledge coefficient may be calculated as:

$$σ = \frac{\$25 , 000}{\$15 , 000 , 000} = 0.17 \% ,$$

where the consumer's pledge of $25,000 is included in an owner-resident pledge pool. The portfolio-based equity value adjustment (GFIG. 12) is: [symbol] =0.17%*$48,357.19=$80.60.

As discussed above, it is assumed that the minimum income reserve is: α=0.

The contractual obligation adjustment factor (FIG. 13) is: β=$73.12−$80.60=—$7.47

The discounted base payment becomes: BP=$787.50−$7.47=$780.03, as shown in FIG. 16B.

The total portfolio-based contractual obligation for the consumer therefore becomes: P=$780.03+$1,389.38=$2,169.40 and the consumer's payment reduction benefit becomes: PR=$2,250−$2,169.40=$80.60, as shown in FIG. 16B.

Therefore, in the first month of occupancy, Sarah would receive a payment reduction benefit of $80.60 on her pledge of $25,000.

Although a linear relationship is illustrated in FIG. 15, in other embodiments COE 101b may use parabolic, quadratic, hyperbolic logarithmic or other kind of relationship graphs.

In this disclosure, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this disclosure, language of “at least one of X, Y, and Z” and “one or more of X, Y and Z” can be construed as X only, Y only, Z only, or any combination of two or more items X, Y, and Z (e.g., XYZ, XY, YZ, XZ, and the like). Similar logic can be applied for two or more items in any occurrence of “at least one . . . ” and “one or more . . . ” language.

Persons skilled in the art will appreciate that in some examples, the functionality of devices and/or methods and/or processes described herein can be implemented using pre-programmed hardware or firmware elements (e.g., application specific integrated circuits (ASICs), electrically erasable programmable read-only memories (EEPROMs), etc.), or other related components. In other examples, the functionality of the devices and/or methods and/or processes described herein can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative examples and modifications possible, and that the above examples are only illustrations of one or more examples. The scope, therefore, is only to be limited by the claims appended hereto.

What is claimed is:

1. A property ownership management system, comprising:
at least one local property management server;
a first interface for communicating with at least one consumer via a consumer device;
a second interface for communicating with at least one financial institution using secure communications;
a third interface for communicating with the at least one local property management server;
at least one central server configured to
receive via the first interface a consumer request to purchase ownership of a property characterized by consumer preferences selected by filtering property criteria including one or more of a desired location, move in date, alternate move in date, property type, size and living arrangements,
search an availability database for any available property according to the filtered property criteria for matching the selected consumer preferences,
transmit via the first interface at least one property proposal to the consumer device, wherein the property proposal matches at least one of the filtered property criteria,
generate via the consumer device a reservation request to reserve the at least one property proposal, including financial data in support of the reservation request,
receive the reservation request via the first interface,
transmit via the second interface a financial transaction request and the financial data to the at least one financial institution to secure consumer funds,
receive via the second interface consumer funds from the at least one financial institution to complete the financial transaction,
create a contract for recording occupancy rights, equity in the reserved property and the financial transaction,
update the availability database to remove availability of the reserved property,
transmit to the consumer via the first interface confirmation of the contract and notification of a date of occupancy start, and
transmit to the at least one local property management server via the third interface notification regarding change of ownership of the reserved property and move in date.

2. The property ownership management system according to claim 1, further including a fourth interface for communicating with at least one third-party service provider, wherein the at least one central server is further configured to communicate with the at least one third-party service provider to provide a service to the consumer related to occupancy of the reserved property.

3. The property ownership management system according to claim 1, wherein the at least one central server is further configured to
receive from the consumer device via the first interface a consumer request to sell the property,
create and transmit an offer to the consumer device via the first interface to buy the property,
receive from the consumer via the first interface an acceptance of the offer and in response complete an ownership change transaction and record the transaction as a smart contact on a blockchain, and
complete a financial transaction with one of the financial institutions thereby releasing funds to the consumer and storing details of the financial transaction in the smart contact.

4. The property ownership management system according to claim 1, wherein the at least one central server is further configured to
receive from the consumer device via the first interface a consumer request to sell a portion of ownership of a property,
receive from the consumer via the first interface a preferred portion of the current consumer ownership that the consumer wishes to sell,
create and transmit an offer to the consumer device via the first interface,
receive from the consumer via the first interface an acceptance of the offer and in response complete an ownership change transaction and record the transaction as a smart contact on a blockchain,
complete a financial transaction with one of the financial institutions thereby releasing funds to the consumer and storing details of the financial transaction in the smart contact.

5. The property ownership management system according to claim 1, wherein the at least one central server is further configured to
receive from the consumer device via the first interface a consumer request to buy an additional portion of ownership of a property,
create and transmit an offer to the consumer device via the first interface to buy the additional portion of ownership of the property,
calculate a minimum equity required for ownership of additional portion of ownership of the property,
receive from the consumer via the first interface an acceptance of the offer, transmit via the second interface a financial transaction request and the financial data to the at least one financial institution to secure consumer funds,
upon receipt of consumer funds from the at least one financial institution complete an ownership change transaction and record the transaction as a smart contact on a blockchain.

6. The property ownership management system according to claim 1, wherein the at least one central server is further configured to
receive from the consumer device via the first interface a consumer request to change ownership from the property to a second property,
calculate a minimum equity required for ownership of the second property and an amount of equity that the consumer can sell by subtracting the consumer's equity in the property from the price for a current consumer ownership portion of the second property,
search an availability database for an available second property,
transmit via the first interface at least one second property proposal to the consumer device,
generate via the consumer device a reservation request to reserve the at least one second property proposal, including financial data in support of the reservation request,
receive the reservation request via the first interface,
transmit via the second interface a financial transaction request and the financial data to the at least one financial institution to secure consumer funds for the minimum equity required for ownership of the second property,
receive via the second interface consumer funds from the at least one financial institution to complete the financial transaction,
create a smart contract for recording occupancy rights, equity in the second property and the financial transaction,
update the availability database to remove availability of the second property,
update the availability database to add availability of the property, transmit to the consumer via the first interface confirmation of the smart contract and notification of a date of occupancy start for the second property, and
transmit to the at least one local property management server via the third interface notification regarding change of ownership of the reserved second property and move in date.

7. A contractual obligation engine, comprising:
a calculator module;
a suite value module for processing property value;
a database pointing to an equity table for maintaining one or more of consumer equity position values and payment obligations; and
a payment gateway,
wherein the calculator module is configured to
receive a monthly contractual payment obligation value for a property from the database,
receive a base payment value from the database representing costs associated with operating the property,
receive a payment benefit coefficient from the database representing consumer percent equity in the value of the property,
calculate an additional payment value by multiplying the difference between the monthly contractual payment obligation value and the base payment value by the payment benefit coefficient, and
generate a suite-based contractual obligation value payable by the consumer, by summing the base payment value and additional payment value, such that the suite-based contractual obligation value represents a discount of the monthly contractual payment obligation value by a suite-based equity value adjustment related to the payment benefit coefficient.

8. The contractual obligation engine according to claim 7, wherein the calculator module is further configured to
receive a payment pledge coefficient from the database representing consumer percent equity in a portfolio of properties including said property,
receive a total all-suite-based equity adjustment value representing an aggregate payment benefit for all equity owners of the portfolio of properties,
calculate a portfolio-based equity adjustment value by multiplying the total all-suite-based equity adjustment value by the payment pledge coefficient,
calculate a contractual obligation adjustment factor by subtracting the portfolio-based equity adjustment value from the suite-based equity value adjustment,
calculate a discounted base payment value by summing the base payment value and contractual obligation adjustment factor, and
generate a portfolio-based contractual obligation value payable by the consumer by summing the discounted base payment value and additional payment value, such that the portfolio-based contractual obligation value represents a discount of the suite-based contractual obligation value by the portfolio-based equity adjustment value.

9. The contractual obligation engine according to claim 7, wherein the calculator module is further configured to compute and store an EVA (Equity Value Adjustment) comprising a difference between the suite market contractual obligation and the suite-based contractual obligation in the database.

10. The contractual obligation engine according to claim 7, wherein the calculator module is further configured to aggregate and store a total suite-based equity value adjustment comprising a sum of all suite-based equity value adjustments in the database.

11. The contractual obligation engine according to claim 7, wherein the calculator module is further configured to aggregate and store a total portfolio equity comprising a sum of all suite owners' equity and total investors' equity in the database.

12. The contractual obligation engine according to claim 7, wherein the calculator module is further configured to compute and store a portfolio-based equity value adjustment in the database.

13. The contractual obligation engine according to claim 7, wherein the calculator module is further configured to compute and store a contractual obligation adjustment factor comprising a difference between suite-based equity value adjustment and portfolio-based equity value adjustment in the database.

14. The contractual obligation engine according to claim 7, wherein the calculator module is further configured to compute and store a portfolio-based contractual obligation comprising a sum of suite-based contractual obligation and contractual obligation adjustment factor in the database.

15. The contractual obligation engine according to claim 7, wherein the calculator module is further configured to calculate and store a relationship between portfolio payment reduction and pledged portfolio equity,

16. The contractual obligation engine according to claim 15, wherein the relationship is one of either linear, parabolic, quadratic, hyperbolic or logarithmic.
